(19) United States
(12) Patent Application Publication
(10) Pub. No.: US 2002/0174026 A1
(43) Pub. Date: Nov. 21, 2002

(54) Method and apparatus for facilitating the locating of an item

(76) Inventors: Clifford A. Pickover, Yorktown Heights, NY (US); Paul A. Moskowitz, Yorktown Heights, NY (US); William Grey, Millwood, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/861,243

(22) Filed: May 18, 2001

(51) Int. Cl. G06F 17/60

(52) U.S. Cl. 705/26

(57) ABSTRACT

A method, system, apparatus and computer code for locating an item enables a person who desires or needs to locate an item to obtain assistance from another person or a group of people who may be unknown to the person or located geographically disparate from the person. A method includes providing a notification to one or more devices regarding an item to be located, receiving a notification regarding a location of the item, and providing another notification to a different device regarding the location of the item.

### CROSS-REFERENCE TO RELATED PATENT APPLICATION

This patent application is related to co-pending patent application entitled Method and Apparatus for Facilitating the Sending of an Item, which has application Ser. No. ______ and was filed on May 18, 2001, and all of which is incorporated herein by reference.

### FIELD OF THE INVENTION

The present invention relates to a method and apparatus for locating an item and, more particularly, embodiments of the present invention relate to methods, apparatus, and computer program code for enabling a user or device to locate an item on behalf of another user or device.

### BACKGROUND OF THE INVENTION

A person looking for an item (e.g., a book, rare coin, ranch, painting) has many options of where to look. Regardless of whether the person searches for the item by looking through stores, catalogs, World Wide Web sites (“Web sites”), flea markets, etc., the person may go through considerable time and expense trying to locate the item.

Often, a person's search for an item may be limited by the physical location of the person. For example, a person living in Connecticut may have difficulty looking for an item in California. As an even bigger problem, a person located in France may have difficulty looking for an item in New Zealand. Language barriers, lack of needed expertise, and time availability also may limit a person's ability to search for an item.

While some Web sites, such as the Web sites found at www.amazon.com, www.google.com or www.ebay.com help people search for items of interest to the person, the person still must spend the time to browse the Web sites. Unfortunately, there is no ability to obtain help from other people in locating the item. Moreover, a person browsing these Web sites often must go through a series of steps if the person locates an item and wants to send the item to a different person.

It would be advantageous to provide a method and apparatus that overcame the drawbacks of the prior art. In particular, it would be desirable to provide a method and apparatus for facilitating the locating of an object on behalf of one person by benefiting from the efforts of another person or a group of people. In addition, it would be desirable to provide a method and apparatus for allowing a person who locates an item to send the item to another person, even if the other person was not actively looking for, or even aware of, the item.

### SUMMARY OF THE INVENTION

Embodiments of the present invention provide a system, method, apparatus, and computer program code for facilitating a search and locating of an item for one person by another person or group of people. In some embodiments, a person or device locating an item of interest to another person or device, or believed to be of interest to another person or device, may be requested, allowed or instructed to complete a task or other instruction associated with the item (e.g., purchasing the item, clicking on an image of the item, sending out a notification that the item has been located). As a result, the person looking for the item is able to receive the benefit of having another person look for the item or complete a task associated with the item or to receive the benefit of the other person locating the item. Locating an item may include determining a specific address for the item, determining a specific store or address for a store or Web site supplying, displaying selling, or possessing the item, locating a person or entity who owns or possesses the item, identifying a storage facility holding or storing the item, etc. Thus, a “location” of an item might be in very broad terms for some embodiments. In some embodiments, “locating an item” might be more specific and become as detailed as identifying the exact row, bin, rack, isle, shelf, etc. that an item is stored at. An item can be any tangible or intangible object and may be of interest to a device, person or other entity. An item might also be or involve a service.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating the locating of an item includes providing a first notification to a first device, the first notification including data indicative of an item to be located; receiving a second notification, the second notification including data indicative of a location of the item; and providing a third notification to a second device, the third notification including data indicative of the location of the item. In other embodiments, a method for facilitating the locating of an item includes determining an item to be located and an instruction associated with the item; providing a first notification, the first notification including data indicative of the item and the instruction; receiving a second notification, the second notification including data indicative of a location of the item; and providing a third notification, the third notification including data indicative of at least one of the location of the item and a receipt of the second notification. In further embodiments, a method for facilitating the locating of an item includes providing a notification of an item, the item having an associated instruction; providing an indication of a single action that can be performed to implement the instruction; and receiving an indication of a completion of the single action. In additional embodiments, a method for facilitating the locating of an item includes providing information identifying an item to be located; and providing information regarding a single action to be performed when the item is located. In further embodiments, a method for facilitating the locating of an item includes determining an item to be located and an instruction associated with the item that is to be completed when the item is located; and providing a notification to a first device, the notification including data indicative of the item and the instruction. In more embodiments, a method for facilitating transfer of an item includes receiving a notification regarding an item and a single action associated with the item; determining a location of the item; and completing the single action. In other embodiments, a method for facilitating transfer of an item includes receiving a notification regarding an item to be located and a single action associated with the item, wherein completion of the single action will cause a designated event to occur; determining a location of the item; and completing the single action when the item's location is determined.

According to further embodiments of the present invention, a system for facilitating locating of an item includes a memory; a communication port; and a processor connected to the memory and the communication port, the processor being operative to: provide a first notification to a first device, the first notification including data indicative of an item; receive a second notification, the second notification including data indicative of a location of the item; and provide a third notification to a second device, the third notification including data indicative of the location of the item. In other embodiments the processor may be operative to determine an item to be located and an instruction associated with the item; provide a first notification, the first notification including data indicative of the item and the instruction; receive a second notification, the second notification including data indicative of a location of the item; and provide a third notification, the third notification including data indicative of at least one of the location of the item and a receipt of the second notification. In further embodiments, the processor may be operative to provide a notification of an item, the item having an associated instruction; provide an indication of a single action that can be performed to implement the instruction; and receive an indication of a completion of the single action. In additional embodiments, the processor may be operative to provide information identifying an item to be located; and provide information regarding a single action to be performed when the item is located. In further embodiments, the processor may be operative to determine an item to be located and an instruction associated with the item that is to be completed when the item is located; and provide a notification to a first device, the notification including data indicative of the item and the instruction. From a client side perspective, the processor may be operative to receive a notification regarding an item and a single action associated with the item; determine a location of the item; and complete the single action. In other embodiments, the processor may be operative to receive a notification regarding an item to be located and a single action associated with the item, wherein completion of the single action will cause a designated event to occur; determine a location of the item; and complete the single action when the item's location is determined.

According to another embodiment of the present invention, an apparatus for facilitating locating of an item includes means for sending a first notification to a first device, the first notification including data indicative of an item; means for obtaining a second notification, the second notification including data indicative of a location of the item; and means for sending a third notification to a second device, the third notification including data indicative of the location of the item. In other embodiments an apparatus for facilitating locating of an item includes means for identifying an item to be located and an instruction associated with the item; means for sending a first notification, the first notification including data indicative of the item and the instruction; means for obtaining a second notification, the second notification including data indicative of a location of the item; and means for sending a third notification, the third notification including data indicative of at least one of the location of the item and a receipt of the second notification. In further embodiments, an apparatus for facilitating locating of an item includes means for sending a notification of an item, the item having an associated instruction; means providing an indication of a single action that can be performed to implement the instruction; and means for obtaining an indication of a completion of the single action. In additional embodiments, an apparatus for facilitating locating of an item includes means for sending information identifying an item to be located; and means for sending information regarding a single action to be performed when the item is located. In further embodiments, an apparatus for facilitating locating of an item includes means for identifying an item to be located and an instruction associated with the item that is to be completed when the item is located; and means for sending a notification to a first device, the notification including data indicative of the item and the instruction. In still further embodiments, an apparatus for facilitating the locating of an item includes means for obtaining a notification regarding an item and a single action associated with the item; means for identifying a location of the item; and means for implementing the single action. In other embodiments, an apparatus for facilitating locating of an item includes means for obtaining a notification regarding an item to be located and a single action associated with the item, wherein completion of the single action will cause a designated event to occur; means for identifying a location of the item; and means for implementing the single action when the item's location is determined.

According to a further embodiment of the present invention, a computer program product in a computer readable medium for facilitating locating of an item includes first instructions for sending data indicative of an item to a first device; second instructions for receiving data indicative of a location of the item; and third instructions for sending data indicative of the location of the item to a second device. In other embodiments a computer program product in a computer readable medium for facilitating locating of an item includes first instructions for identifying an item to be located and an instruction associated with the item; second instructions for sending a first notification, the first notification including data indicative of the item and the instruction; third instructions for obtaining a second notification, the second notification including data indicative of a location of the item; and fourth instructions for sending a third notification, the third notification including data indicative of at least one of the location of the item and a receipt of the second notification. In further embodiments, a computer program product in a computer readable medium for facilitating locating of an item includes first instructions for sending a notification of an item, the item having an associated instruction; second instructions for sending provide an indication of a single action that can be performed to implement the instruction; and third instructions for obtaining an indication of a completion of the single action. In additional embodiments, a computer program product in a computer readable medium for facilitating locating of an item includes first instructions for sending information identifying an item to be located; and second instructions for sending information regarding a single action to be performed when the item is located. In further embodiments, a computer program product in a computer readable medium for facilitating locating of an item includes first instructions for identifying an item to be located and an instruction associated with the item that is to be completed when the item is located; and second instructions for sending a notification to a first device, the notification including data indicative of the item and the instruction. In still further embodiments, a computer program product in a computer readable medium includes first instructions for obtaining a notification regarding an item and a single action associated with the item; second instructions for identifying a location of the item; and third instructions for implementing the single action. In other embodiments, a computer program product in a computer readable medium for facilitating locating of an item includes first instructions for obtaining a notification regarding an item to be located and a single action associated with the item, wherein completion of the single action will cause a designated event to occur; second instructions for identifying a location of the item; and third instructions for implementing the single action when the item's location is determined.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a flowchart of a fourth embodiment of a method in accordance with the present invention;

FIG. 5 is a flowchart of a fifth embodiment of a method in accordance with the present invention;

FIG. 6 is a block diagram of system components for an embodiment of an apparatus usable with the methods of FIGS. 1-5;

FIG. 7 is a block diagram of system components for the server of FIG. 6;

FIG. 8 is an illustration of a representative user device database of FIG. 7;

FIG. 9 is an illustration of a representative item database of FIG. 7; and

FIG. 10 is an illustration of a representative user database of FIG. 7.

### DETAILED DESCRIPTION

Applicants have recognized that there is a need for systems and methods that help a person locate items of interest to the person. For example, a person may be interested in locating an antique car, a signature of a famous person, an article on a rare disease, a specific type of cross-bow, a particular orchid, or a special brand of South American coffee. In fact, an item may be anything of interest to a particular person, entity or device. An item might be any tangible or intangible product or service, including those that must be transferred in digital or electronic format. As more specific examples, an “items” can include things like movie tickets, software, information, images (digital or printed), multimedia programs or applications (transferred in digital format over a network or physical embodiments), coupons, stocks and bonds, consumer electronics products, cash, financial service, cleaning services, programming services, etc. A first party may “send” a service to a second party by sending a notification regarding: the availability of the service, a reservation for the service made by the first party on behalf of the second party, a purchase of the service by the first party on behalf of the second party, etc. Alternatively, a first party may “send” a service to a second party by sending the second party an electronic or printed coupon, token, code, ticket, etc. that entitles the second party to receive or benefit from the service. As another alternative, a first party may send a service to a second party by activating or starting the service (e.g., cable television service).

Applicants also have recognized that there is a need to provide systems and methods for completing a task, single action or other instruction on behalf of another person once an item of interest to the person has been located. For example, once an item of interest for a person is located, the person may want to have the item purchased and/or shipped to a designated address, a bid placed on the item, an evaluation performed on the item, etc. Alternatively, the person may want to receive an email message or other notification that the item has been located. In some embodiments, an instruction may involve one or more tasks, responsibilities, events, procedures or actions (which may include one or more single actions) that need to occur or need to be completed, performed, initiated, etc.

Embodiments of the present invention provide such capabilities by providing information regarding an item of interest to a person to at least one other device or person and, preferably, to a group of devices or people. If another person finds the item of interest, he or she can provide a notification regarding the item's location and perhaps complete another action with regard to the item (e.g., purchasing the item, sending the item, reserving the item). A message or other notification can be sent to the person interested in locating the item to let the person know that the item has been located and/or that another action has or will be taken regarding the item. These and other features will be discussed in further detail below, by describing a system, individual devices, and processes according to embodiments of the invention.

Process Description

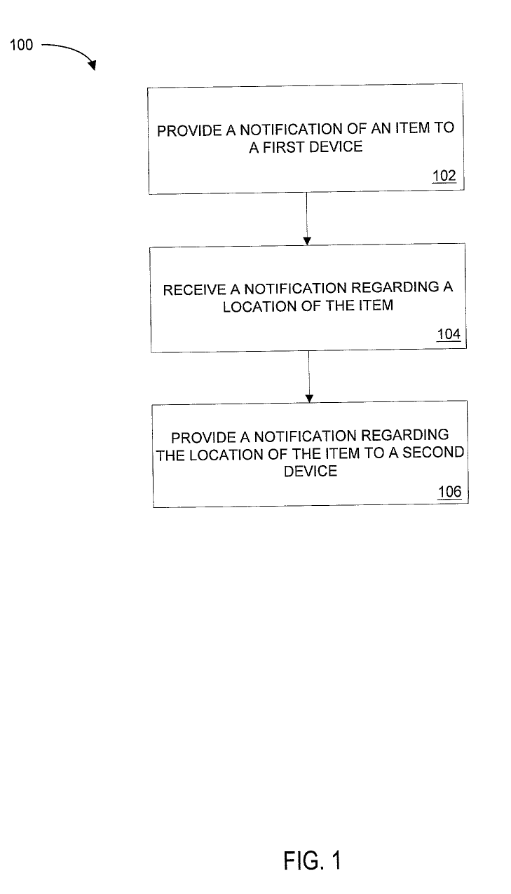

Reference is now made to FIG. 1, where a flow chart 100 is shown that represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 can be implemented by a server or other device, as will be discussed in more detail below. In some embodiments, the method 100 may be implemented by a central authority or entity that helps one or more users locate items of interest by providing information regarding the items to one or more other people.

Processing begins at a step 102 during which a notification of an item to be located is provided to a first device. For example, the notification might be sent by a server to one or more user or client devices (e.g., personal digital assistants, cellular telephones, pagers) to inform or alert the users carrying or using the devices that they should be on the lookout for the item, either passively or actively. The server might send the notification on behalf of another person who wants to locate the item.

The notification provided during the step 102 might be sent or transmitted by email message, instant message communication, Web page or bulletin board posting, XML (Extensible Mark-up Language) feed, HTML, HTTP or FTP transmission, radio or other wireless signal, cellular telephone call, facsimile transmission, or other form of electronic signal or other communication. The notification sent during the step 102 can be in any form or format.

In some embodiments, the notification sent during the step 102 might include information or other data indicative of or otherwise regarding an identifier associated with the item, a desired location for the item, a desired condition of the item, a desired price for the item, a desired amount of the item, a desired maximum price for the item, a desired shipping date for the item, a desired delivery or shipping process or address for the item, a name and/or description of the item, a desired configuration of the item, compensation that might be provided to a person locating the item, a payment term for the item, etc. Information regarding on or more items might be stored in, or accessed from, a database. Information regarding an item might be received from a person or entity looking for the item, a manufacturer or supplier of the item, a person having experience with the item or expertise regarding the item, etc.

Compensation provided to a person or entity looking for or locating an item, or performing an action regarding the item, might be in monetary and/or non-monetary form and include, for example, one of more of the following: cash, frequent flyer miles, gift certificates, coupons, rebates, discounts, long distance calling minutes, gambling or gaming tokens, charitable donations, access to benefits (e.g., movies, spa treatments, Web access), scrip, recognition awards, vacation packages, etc.

The notification sent during the step 102 might be sent to one or more devices depending on location or availability of the devices and/or on information regarding people associated with the devices. For example, suppose someone is looking for a rare coin. The notification sent during the step 102 might be sent only to those devices associated with coin dealers (e.g., a specific coin dealer's computer), coin collectors, museums with coin collections, numismatic organizations, etc. The notification also might be sent to people good at locating items, even if the people do not have an interest or expertise in coins or numismatics. Sending the notification to people without a particular expertise may still be helpful if those people know other people with a desirable expertise and forward or send the notification to those other people. As another example, suppose someone is looking for a Russian religious icon. The notification sent during the step 102 might be sent only to devices currently located in Russia or Eastern Europe, devices associated with dealers in religious artifacts (e.g., a specific dealer's facsimile machine), devices associated with people other than dealers that are currently located in Russia, devices associated with churches located in Russia, etc. As a third example, suppose someone is looking for an article on a rare butterfly. The notification sent during the step 102 might be sent to devices associated with natural history museums, devices associated with libraries, devices associated with experts on butterflies (e.g., a specific expert's pager), etc. If one of the devices is not available or accessible, the notification might not be sent to that device during the step 102. For example, a server or other device implementing the method 100 might ascertain which, if any, user devices can receive messages prior to sending the notification during the step 102. Information regarding the location, availability, expertise, etc. of devices and/or users may be stored in, and accessed from, one or more databases, such as a user device database or a user database.

In some embodiments, the notification sent during the step 102 may be sent only to designated individuals or devices associated with the designated individuals. For example, a person looking for a specific item may want a specific person or group of people to look for the item on his or her behalf. The person looking for the item may set up the criteria or filter for the item and for the specific person or group of person to look for the item.

In some embodiments, the notification sent during the step 102 might include an instruction or indication of a single action that is to be completed or performed when the item is located. For example, a person looking for an item may want a person locating the item to purchase the item, ship the item, bid on the item, reserve the item, place the item in an electronic shopping cart, order the item, send a notification regarding the item, etc. The notification sent during the step 102 might include an instruction that informs or instructs a person locating the item to complete one or more of the aforementioned actions when the person locates the item. In some embodiments, an instruction included in the notification sent during the step 102 also may include information regarding how, where, when, under what circumstances, etc. a person locating the item should send a notification (which might be received during step 104 in the method 100) after locating the object and/or what information should be included in the notification.

There are many single actions that might be indicated in the notification sent during the step 102. For example, a single action may comprise one of the following: clicking a mouse button when a cursor is positioned over a designated area of an identifier (e.g., a name, image) associated with an item; clicking on a mouse button when a cursor is positioned over a designated area of a Web page; clicking on a mouse button when a cursor is positioned over a link displayed on a Web page; entering or selecting a designated URL (uniform resource locator) via browser software operating on a user device; selecting a specific channel using a television remote control; contacting a specific portion of a touchscreen; calling or dialing a specific telephone number; accessing a specific device; making a specific command using a television remote control; detecting a presence of an item; determining or detecting a characteristic (which may be unique) of the item; depressing a designated key on a key pad; providing a designated audible signal; moving an item indicated during the step 102 within a designated proximity of another item; moving an item indicated during the step 102 to a designated location; moving an item indicated during the step 102 within range of a device capable of detecting a presence of the item; scanning a code (e.g., a barcode), identifier, text, or image associated with an item; navigating to a designated Web page; entering a designated code; making a designated sound; selecting using a pointing device; moving a cursor over a designated area of an identifier associated with an item indicated during the step 102, etc. An instruction may include one or more of the single actions.

In some embodiments, completion of the single action indicated in a notification sent during the step 102 regarding an item may cause a designated event to occur. For example, completing one of the single actions listed above might cause a notification regarding the item to be sent to a designated postal or electronic address, the item to be sent to a specific address, the item to be purchased, shipped, ordered, reserved, bid on, placed in an electronic shopping cart, etc.

In some embodiments, a server or other device implementing the method 100 may select a single action to be performed by a person receiving the notification sent during the step 102 depending on what kind of user device the person has or is using, what a person looking for the time has instructed the single action to be, what makes practical sense regarding the item being looked for or the type of location (e.g., Web site, flea market) the item being looked for is likely to be found in, etc.

In some embodiments, a server or other device implementing the method 100 might receive a notification regarding the item prior to the step 102. For example, a first person looking for a specific item (e.g., a rare piece of pottery) might send an email message to a server from a user device (e.g., computer, terminal) indicating that the first person is looking for the specific item. The server may then send the notification during the step 102 to a person or group of people, via user devices associated with the person or group of people, to inform the person of group of people to actively search for and/or passively be on the lookout for the item. In some embodiments, a server or other device implementing the method 100 might receive a request to locate an item or determine that a desire or need for an item exists (e.g., a server operating at a rare book shop may monitor electronic chat rooms and bulletin boards and ascertain a hidden demand for a particular rare book). Thus, in some embodiments, the method 100 may include a step of determining an item to be located.

During a step 104, a notification is received regarding the location of the item involved in the step 102. For example, a server or other device might send out the notification during the step 102 on behalf of a person looking for an item. During the step 104, the server receives a notification that indicates a location of the item. Presumably, but not necessarily, the notification received during the step 104 is from one of the devices to which the notification was sent during the step 102. The notification received during the step 104 may be received directly or indirectly from a user or client type device (e.g., cellular telephone, kiosk, personal digital assistant).

The notification received during the step 104 may be in any printed or electronic format and may contain information or other data regarding where the item mentioned in the notification sent during the step 102 can be found. Alternatively, the notification received during the step 104 may include information or other data regarding a place (e.g., a Web site, catalog, department store) where information relating to the location of the item can be found.

In some embodiments, the notification received during the step 104 may include information or other data indicative of a Web site or other location where information regarding the item or its location can be found; a name, description and/or price of the item; a delivery, shipping, or payment term associated with the item; availability of the item; packaging of the item; a supplier or manufacturer or the item; an identifier (e.g., code, model number, serial number) associated with the item; etc. In some embodiments, the notification received during the step 104 also may include information or other data indicative of a completion of a single action associated with the item and/or of an instruction associated with the item, information regarding the single action and/or instruction being included in the notification sent during the step 102. Completion of the instruction or single action may cause a designated action or event to occur.

During a step 106, a notification regarding the location of the item is sent or otherwise provided to a second device. For example, a server implementing the method 100 may want to send a notification to a person looking for an item once the notification regarding the location of an item is received during the step 104. The server may have sent the notification during the step 102 on behalf of the person to one or more devices and received a notification during the step 104 that the item has been located.

The notification sent during the step 106 may be in any printed or electronic form or format and may contain information or other data regarding where the item mentioned in the notification sent during the step 102 can be found. In some embodiments, the notification provided during the step 106 may include information or other data indicative of a Web site or other location where information regarding the item can be found; a name, description and/or price of the item; a delivery, shipping, or payment term associated with the item; availability of the item; packaging of the item; a supplier or manufacturer or the item; an identifier (e.g., code, model number, serial number) associated with the item; instructions associated with the item, etc. In some embodiments, the notification provided during the step 106 also may include information or other data indicative of a completion of a single action associated with the item and/or of an instruction associated with the item, information regarding the single action and/or instruction being included in the notification sent during the step 102.

In some embodiments, the notification sent during the step 106 might be sent to one or more devices depending on location or availability of the devices. For example, a person looking for a particular fishing lure might have both a cellular telephone and a computer. A server or other device implementing the method 100 might want to send a notification to the person during the step 106 that the fishing lure has been located. The server or other device may determine that the person cannot receive telephone calls via the cellular telephone but can receive email messages sent to the person's computer or Internet Service Provider (ISP). Thus, the server or other device may send the notification to the computer during the step 106 since the computer is available and accessible and the cellular telephone is not at the current time.

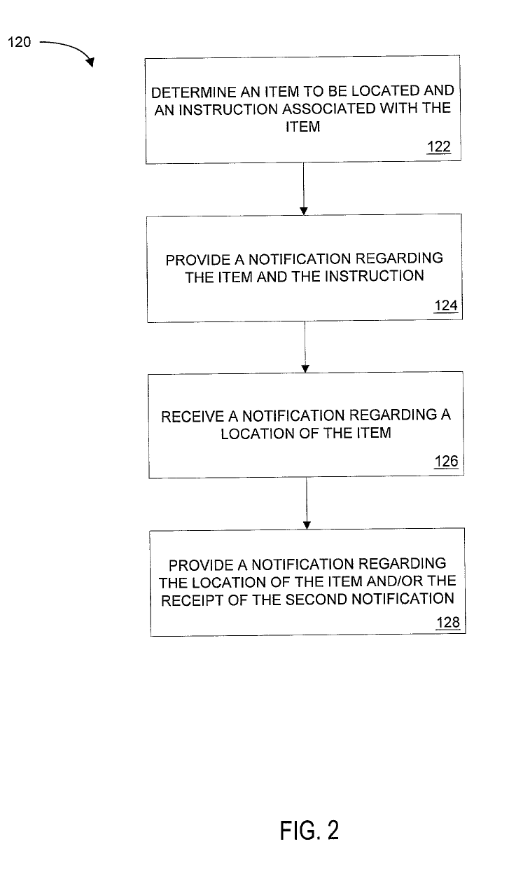

Reference is now made to FIG. 2, where a flow chart 120 is shown which represents the operation of a second embodiment of the present invention. The particular arrangement of elements in the flow chart 120 is not meant to imply a fixed order to the steps; embodiments of the present invention can be practiced in any order that is practicable. In some embodiments, some or all of the steps of the method 120 can be implemented by a server or other device, as will be discussed in more detail below.

Processing begins at a step 122 during which a server or other device determines an item to be located and an instruction associated with the item. There are many ways the server or the device might determine an item to be located. For example, a server or other device may receive a message or other notification from a person looking for an item. Alternatively, the server or other device may detect or ascertain a shortage of an item. For example, a server might determine that a piano manufacturer is running low of a specific part needed for a particular kind of piano and that orders for the particular piano type are likely to increase in the future. An instruction may be or include one or more tasks, jobs, actions (including single actions), procedures, etc.

There also are many ways in which the server or other device might determine an instruction associated with the item. For example, the server or other device may receive a message or other notification from a person looking for an item in which the person indicates what the person wants to have happen if and when the item is located. For example, the person might want the item purchased, ordered, reserved, etc. by whomever locates the item and may indicate as such in the message or other notification. As another example, the person looking for the item may want to receive a notification when the item has been located. Thus, the instruction determined during the step 122 will indicate that such notification should be sent and also may include information regarding how, where, when and/or under what circumstances the notification should be sent. In some embodiments, completion of the instruction may cause a designated action or event to occur.

During a step 124, a server or other device provides a notification regarding the item and instruction determined during the step 122 to one or more devices. The notification sent during the step 124 can be in any form or format. For example, the notification might be sent by a server to one or more user or client devices (e.g., personal digital assistants, cellular telephones, pagers). The notification might be sent or transmitted by email message, instant message communication, Web page or bulletin board posting, XML (Extensible Mark-up Language) feed, HTTP, HTML or FTP transmission, radio or other wireless signal, cellular telephone call, facsimile transmission, or other form of electronic signal or communication. The step 124 is similar to the step 102 previously discussed above.

In some embodiments, the notification sent during the step 124 might include information or other data indicative of or otherwise regarding an identifier associated with the item, a desired location for the item, a desired condition of the item, a desired price for the item, a desired amount of the item, a desired maximum price for the item, a desired shipping date for the item, a desired delivery or shipping process or address for the item, a name and/or description of the item, a desired configuration of the item, compensation that might be provided to a person locating the item, a payment term for the item, etc.

During a step 126, a notification is received regarding the location of an item. The step 126 is similar to the step 104 previously described above. The notification received during the step 126 may be in any printed or electronic format and may contain information or other data regarding where the item mentioned in the notification sent during the step 124 can be found. Alternatively, the notification received during the step 126 may include information or other data regarding a place (e.g., a Web site, catalog, department store) where information relating to the location of the item can be found.

In some embodiments, the notification received during the step 126 may include information or other data indicative of a Web site or other location where information regarding the item can be found; a name, description and/or price of the item; a delivery, shipping, or payment term associated with the item; availability of the item; packaging of the item; a supplier or manufacturer or the item; an identifier (e.g., code, model number, serial number) associated with the item; instructions associated with the item, etc. In some embodiments, the notification received during the step 126 also may include information or other data indicative of a completion of the instruction determined during the step 122 and indicated in the notification sent during the step 124.

During an optional step 128, a server or device may provide a notification regarding the location of the item to one or more devices. Alternatively, the notification sent during the step 128 may include information or other data indicate or related to the notification received during the step 126. For example, a server implementing the method 120 may want to send a notification to a person looking for an item once the server receives the notification regarding the location of an item during the step 126. The server may have sent the notification during the step 124 on behalf of the person looking for the item to one or more devices and received a notification during the step 126 that the item has been located.

The step 128 is similar to the step 106 previously discussed above. The step 128 might not be used or implemented in all embodiments of the method 120. The notification sent during the step 128 may be in any printed or electronic form or format and may contain information or other data regarding where the item mentioned in the notification sent during the step 124 can be found. In some embodiments, the notification provided during the step 128 may include information or other data indicative of a Web site or other location where information regarding the item can be found; a name, description and/or price of the item; a delivery, shipping, or payment term associated with the item; availability of the item; packaging of the item; a supplier or manufacturer or the item; an identifier (e.g., code, model number, serial number) associated with the item; etc. In some embodiments, the notification received during the step 128 also may include information or other data indicative of a completion of the instruction determined during the step 122 and indicated in the notification sent during the step 124. In some embodiments, the notification sent during the step 128 might be sent to one or more devices depending on location or availability of the devices or depending the location or characteristics of the people associated with the devices.

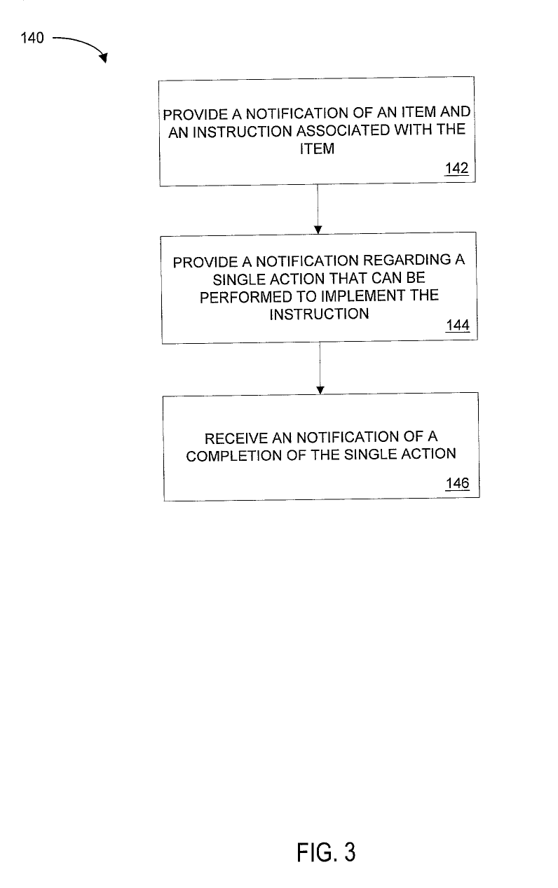

Reference is now made to FIG. 3, where a flow chart 140 is shown which represents the operation of a third embodiment of the present invention. The particular arrangement of elements in the flow chart 140 is not meant to imply a fixed order to the steps; embodiments of the present invention can be practiced in any order that is practicable. In some embodiments, some or all of the steps of the method 140 can be implemented by a server or other device, as will be discussed in more detail below.

Processing begins at a step 142 during which a server or other device provides a notification regarding an item to be located and an instruction associated with the item. The step 142 is similar to the steps 102 and 122 previously discussed above. In some embodiments, the method 140 may include a step of determining an item to be located prior to the step 142. In some embodiments, a server or other device conducting the step 140 may display an image, icon, identifier, description, name, etc. on a Web page to provide the notification of the item.

During a step 144, the server or other device provides a notification regarding a single action that can be performed to implement or otherwise satisfy the instruction. A single action might be any one of a variety of things, as previously discussed above. In general, the single action is linked to the instruction so that the instruction can be implemented with a modicum of effort. For example, an instruction may involve selecting or identifying an address to send an item to and purchasing the item. A single action (e.g., selecting or clicking on an icon on a computer display) may be identified that can accomplish both tasks when a person completes the single action. In some embodiments, an instruction regarding an item might be or include one or more of the following: selecting or identifying the item, send the item to a designated electronic or postal address, sending a notification regarding the location or other attribute of the item, purchasing the item, determining current or future availability of the item, determining a condition or price of the item, determining a payment, shipping or delivery term associated with the item, bidding on, reserving or ordering the item, placing the item in an electronic shopping cart, etc.

In some embodiments, the step 142 may be combined with the step 142 such that a single notification provides all of the information. In some embodiments the steps 142 and 144 may be performed in opposite orders. The notifications provided during the steps 142, 144 may be sent to specific devices or users depending on the location of the devices and/or users, the expertise, backgrounds, etc. of the users, the availability or accessibility of the devices or users, etc. Information regarding the location, availability, expertise, etc. of devices and/or users may be stored in, and accessed from, one or more databases, such as a user device database or a user database.

During a step 146, a notification is received that the single action indicated during the step 144 has been completed. In some embodiments, the notification received during the step 146 may include other information including, for example, information or other data indicative of a Web site or other location where information regarding the item can be found; a name, description and/or price of the item; a delivery, shipping, or payment term associated with the item; availability of the item; packaging of the item; a supplier or manufacturer or the item; an identifier (e.g., code, model number, serial number) associated with the item; etc.

In some embodiments, a device receiving the notification received during the step 146 may itself send a notification to one or more devices, the notification including some or all of the information in the notification received by the device during the step 146.

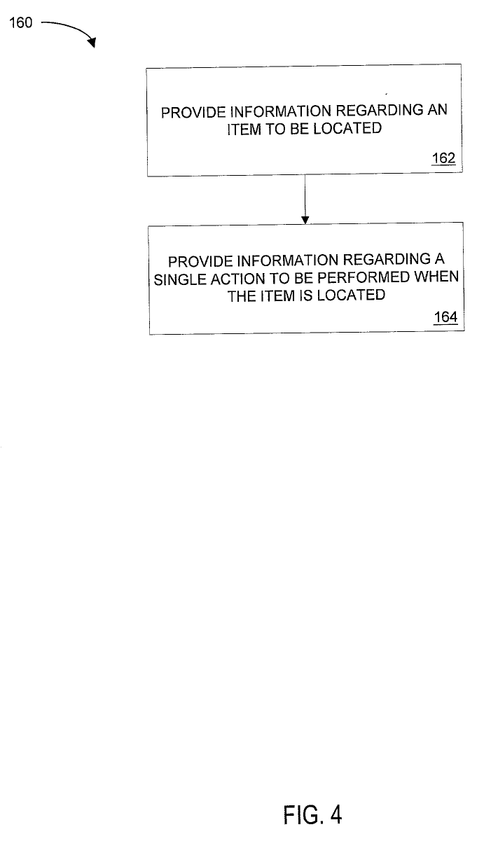

Reference is now made to FIG. 4, where a flow chart 160 is shown which represents the operation of a fourth embodiment of the present invention. The particular arrangement of elements in the flow chart 160 is not meant to imply a fixed order to the steps; embodiments of the present invention can be practiced in any order that is practicable. In some embodiments, some or all of the steps of the method 160 can be performed by a server or other device.

The method 160 can be implemented by a server or other device. In some embodiments, a server might implement the method 160 after the server has received a message from a user device regarding an item of item to a particular person. Thus, the server might determine an item to be located by receiving the message from the person. In other embodiments, a server might implement the method 160 on behalf of a store, organization, etc. when the server has determined that such store, organization, etc. desires or is in need of a particular item. Thus, the server might determine an item to be located by actively checking inventory levels, gift registries, wish lists, online bulletin board or chat room postings, etc. that indicate or express a desire or need to locate the item. The server might implement the method 160 periodically for a specific item or on an as-needed or as-requested basis for the specific item.

Processing begins at a step 162 during which information regarding an item to be located is provided. The step 162 is similar to the step 102 previously discussed above. The information provided during the step 162 can be in any form or format and might be sent or transmitted by email message, instant message communication, XML feed, Web page or bulletin board posting, HTML, HTTP or FTP transmission, radio or other wireless signal, cellular telephone call, facsimile transmission, or other form of electronic signal or communication. The information provided during the step 162 can include any information associated with the item such as, for example, an identifier associated with the item, a desired location for the item, a desired condition of the item, a desired price for the item, a desired amount or volume of the item, a desired maximum price for the item, a desired shipping date for the item, a desired delivery or shipping process or address for the item, a name and/or description of the item, a desired configuration of the item, compensation that might be provided to a person locating the item, a payment term for the item, etc. Information regarding items might be store in, or accessed from, a database. Information regarding items might be received from a person or entity looking for the item, a manufacturer or supplier of the item, a person having experience with the item or expertise regarding the item, etc. The information provided during the step 162 may be sent to specific devices or users depending on the location of the devices and/or users, the expertise, backgrounds, etc. of the users, the availability or accessibility of the devices or users, the type of item to be located, etc.

During a step 164, information is provided regarding a single action to be completed when the item indicated during the step 162 is located. The information provided during the step 162 can be in any form or format and might be sent or transmitted by email message, instant message communication, XML feed, Web page or bulletin board posting, HTML, HTTP or FTP transmission, radio or other wireless signal, cellular telephone call, facsimile transmission, or other form of electronic signal or communication. The information provided during the step 164 might be provided along with the information provided during the step 162 such that the steps 162, 164 are combined or performed in the opposite order. There are many single actions that might be indicated in the information provided during the step 164, as previously discussed above.

In some embodiments of the method 160, a server or other device implementing the method 160 may receive a message or other notification that the single action has been completed. In response to such notification, the server or other device might provide a message or other notification to one or more devices that includes information or other data indicative of a location of the item, a completion of the single action, etc.

In some embodiments of the method 160, a completion of the single action indicated during the step 164 may cause a designated event to occur. For example, completing one of the single actions described above might cause a notification regarding the item to be sent to a designated postal or electronic address, the item to be sent to a specific address the item being purchased, shipped, ordered, reserved, bid on, placed in an electronic shopping cart, etc.

In a variation of the method 160, information might be provided that indicates that an item is available, as opposed to indicating that the item is to be located. For example, the information might be displayed on a Web page, included in an email message, etc. In addition, information might be provided that describes a single action that can be or is to be completed with regard to the item. For example, a Web page might display an image of an item and descriptive text that indicates that a person can send the item to a friend by merely clicking on the image of the item. The address for the friend might be displayed on the Web page or indicated by the person prior to clicking on the image of the item. Either the person or the person's friend may be charged for the item. With this variation, a person browsing a Web site might be able to send an item to an address associated with someone other than the person, even if no one associated with the addresses is actively looking for the item or attempting to locate the item. Thus, this variation of the method 160 allows a person identifying the item or the availability of the item to send the item as a gift or otherwise unannounced to someone else. Address or other contact information regarding the other person might be stored in, or accessed from, a user information database. For example, a database might store information about a person, including the name and home mailing address for a friend of the person. When a Web site displays an item to the person on a Web page, the Web site might access the database and display information that indicates that if the person completes a single action (e.g., the person hits the “enter” key on their computer keyboard), the item will be sent automatically to the friend. Either the person and/or the friend might be charged for the item.

In some embodiments of this variation of the method 160, a server or other device might select an address to send the item to based on the item itself or on the type of item. For example, a person may have several addresses associated with him or her in a user information database. Each of the addresses may have information that indicates what kind of items a person associated with the address might be interested in. For example, a person might have three addresses associated with him or her in a user information database. Reviewing records or entries in the databases for people associated with the addresses may indicate that one of the people is interested in automobiles, one is interested in cooking, and one is interested in art history. When the person locates an item or is presented with information regarding the item, additional information might also be provided that will allow the person to complete a single action that will send the item to one of the addresses associated with one of the three people. If the item is a cookbook, the address of the person who has an interest in cooking might be used. If the item is a tire repair manual, the address of the person who has an interest in automobiles might be used.

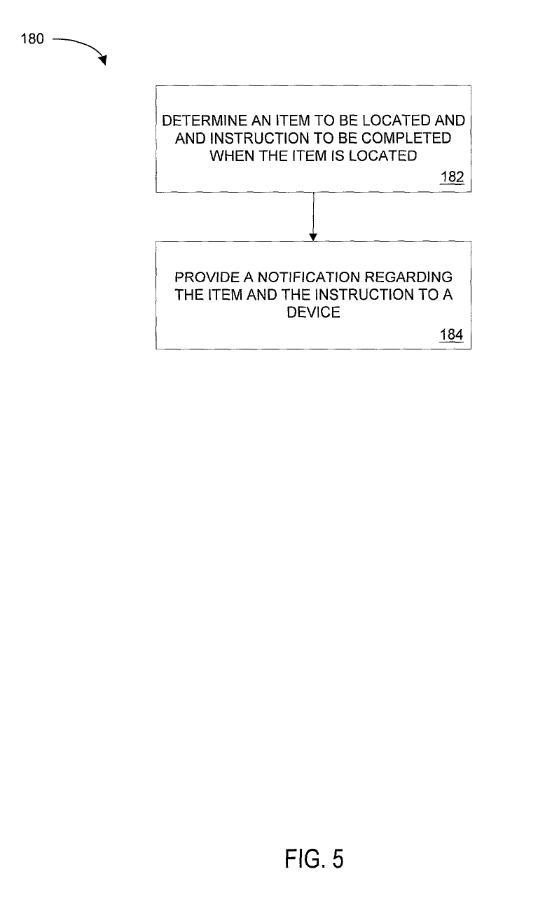

Reference is now made to FIG. 5, where a flow chart 180 is shown which represents the operation of a fifth embodiment of the present invention. The particular arrangement of elements in the flow chart 180 is not meant to imply a fixed order to the steps; embodiments of the present invention can be practiced in any order that is practicable. In some embodiments, some or all of the steps of the method 180 can be implemented by a server or other device, as will be discussed in more detail below.

Processing begins at a step 182 during which a determination is made regarding an item to be located and an instruction to be completed when the item is located. The step 182 is similar to the steps 102 and 122 previously described above. During a step 184, a notification is provided regarding the item and instruction determined during the step 182. The step 182 is similar to the step 124 previously discussed above. The notification provided during the step 184 may include other information regarding the item, the instruction, the sender of the notification, the person or entity looking for the item, etc. The notification provided during the step 184 may be sent to specific devices or users depending on the location of the devices and/or users, the expertise, backgrounds, etc. of the users, the availability or accessibility of the devices or users, the type of item to be located, etc. In some embodiments, completion of the instruction may cause a designated action or event to occur. In other embodiments, the instruction may provide information regarding what a person locating the item is supposed or requested to do after locating the item.

The method 180 may be implemented by a server sending out notifications on behalf of a person, company, device, etc. looking for the item determined during the step 182. For example, prior to the step 182, the server may receive a message or other notification that a person is looking for a specific item or type of item. As another example, the server may check inventory levels for certain items at a store and ascertain that the store is low or in danger of running low on one or more items. During the step 182, the server sends out the notifications regarding the item the person wants to find or the item(s) the store is running low on. In some embodiments, the server may send out such notifications on a regular or periodic basis at the request or instruction of a person, store or other entity or device that wants to maintain a steady stream of certain items or wants to maintain knowledge regarding the availability or location of one or more items.

In a variation of the method 180, information might be provided that indicates that an item is available, as opposed to indicating that the item is to be located. For example, the information might be displayed on a Web page, included in an email message, etc. In addition, information might be provided that describes an instruction that can be or is to be completed with regard to the item. For example, an auction oriented Web page might display an image of an item and descriptive text that indicates that a person can send the item to someone else merely by selecting a button displayed on the Web page. The address for the friend might be displayed on the Web page or indicated by the person prior to clicking on the button. Thus, a person browsing a Web site might be able to send an item to an address associated with someone other than the person, even if no one associated with the addresses is actively looking for the item or attempting to locate the item. In some embodiments, the person might be charged for the item or the other person might be charged for the item.

As previously discussed above, address or other contact information regarding a first person and another person associated with the first person might be stored in, or accessed from, a user information database. For example, a database might store information about a person, including the name and business mailing address for a colleague of the person. When an online bulletin board displays an image, identifier, descriptive text or icon related to an available item to the person, the online bulletin board might retrieve the name and business address information from the database and indicate that if the person completes a single action (e.g., the person clicks on the “I agree” button displayed on the online bulletin board or speaks the phrase “I agree” into the microphone of the person's computer), the item will be sent automatically to the colleague. The colleague may or may not have been looking for the item and may or may not have requested that other people look for the item on his or her behalf.

While the methods discussed above have been focused primarily from a server perspective, the present invention also may be implemented from a client or user device perspective. For example, a user device may receive a notification regarding an item to be located and a single action and/or instruction associated with the item. Presumably, if the user device or a person associated with the user device locates the item or otherwise determines a location of the item, the user device or person should complete the single action. In some embodiments, completion of the instruction or single action might cause a designated event to occur. For example, completing the instruction and/or single action might cause a notification to be sent to the person looking for the item regarding the location, price, condition, etc. of the item. Alternatively, completing the instruction and/or the single action might cause a notification to be sent to the device that sent the original notification regarding the item to be located informing it that the item has been located, where the item is located, etc. From the client perspective, a person with a user device, while conducting an transaction involving an item after locating the item or while looking for the item, might implement a single action that automatically purchases the item, sends the item to a designated address, records a transaction for the item, sends the item to a designated person, etc. The designated person or address may come from a buddy list, address book, email contact list, telephone book or Yellow Pages listing, mailing list, list of charities, museums, libraries, government agencies, libraries, or churches, etc.

In some embodiments, a client or user device might not need to receive a message or other notification regarding an item to be located. For example, a person might be browsing in an online bookstore and see a book that the person knows would be of interest to a friend. A completion of a single action, such as the single actions described above, might be associated with the book such that completing the single action automatically causes the book to be mailed to the friend. Thus, the person has identified the book, identified the single action associated with the book that will cause the book to be sent to a designated address (e.g., the friend's home), which could be an electronic address or a postal address, and completed the single action. The friend might not specifically be looking for the book or asking that others look for the book on his or her behalf. Rather, the person has taken the initiative to complete the single action associated with the book. Either the person and/or the person's friend might be charged for the book. The online bookstore may associate single actions with items to allow people an easy way to purchase gifts for other people, send items to other people, etc. In some embodiments, the person may have to select or designate the address to send the item to prior to or as part of completing the single action, which may come from a person's rolodex, contact list, buddy list, etc., or a user information database that includes information about the person and addresses associated with people, devices or other entities other than the person. While this example has used a person, in some embodiments an entity such as a person or device may identify an item and identify and complete a single action that will send the item to an address associated with a second entity or otherwise cause the item to be sent to the address associated with the second entity.

In some embodiments, a server or other device may enable a person to send an item to an address by completing a single action. For example, the server or other device might provide an indication of an item, such as an image, icon, code or other identifier displayed on a Web page, to a first entity that can be sent to an address associated with a second entity. The indication might include information regarding the availability of the item, the price of the item, delivery or payment term associated with the item, etc. The server or other device might also provide an indication of a single action that can be performed to send the item to the address and receiving an indication of a completion of the single action. The server or other device might send the item in response to the single action and charge the first and/or second entity for the item or for sending the item. In some embodiments, the server or other device may need to determine the address (e.g., receive the address from the first or second entities, look up the address in a contact list or database, etc.). In these embodiments, the second entity might not have been actively looking for the item and might not have requested that other people look for the item on the second entity's behalf.

System

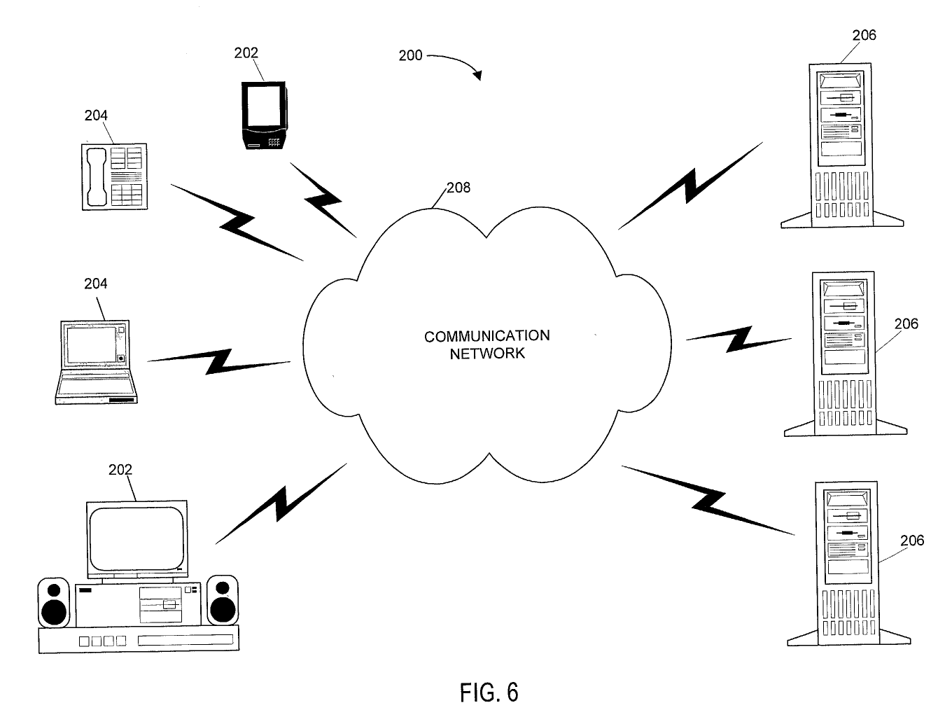

Now referring to FIG. 6, an apparatus or system 200 usable with the methods 100, 120, 140, 160, 180 is illustrated. The apparatus 200 includes one or more user devices 202, 204 that may communicate directly or indirectly with each other or with one or more servers, controllers or other devices 206 via a computer, data, or communications network 208.

A server 206 may implement or host a Web site. A server 206 can comprise a single device or computer, a networked set or group of devices or computers, a workstation, etc. In some embodiments, a server 206 also may function as a database server and/or as a user device. The use, configuration and operation of servers will be discussed in more detail below.

The user devices 202, 204 preferably allow entities to interact with the server 206 and the remainder of the apparatus 200. The user devices 202, 204 also may enable a user to access Web sites, software, databases, etc. hosted or operated by the servers 206. If desired, the user devices 202, 204 also may be connected to or otherwise in communication with other devices. Possible user devices include a personal computer, portable computer, mobile or fixed user station, workstation, network terminal or server, cellular telephone, kiosk, dumb terminal, two-way pager, cable set-top box, personal digital assistant, etc.

Many different types of implementations or hardware configurations can be used in the system 200 and with the methods disclosed herein and the methods disclosed herein are not limited to any specific hardware configuration for the system 200 or any of its components.

The communications network 208 might be or include the Internet, the World Wide Web, or some other public or private computer, cable, telephone or communications network or intranet, as will be described in further detail below. The communications network 208 illustrated in FIG. 6 is meant only to be generally representative of cable, computer, telephone or other communication networks for purposes of elaboration and explanation of the present invention and other devices, networks, etc. may be connected to the communications network 208 without departing from the scope of the present invention. The communications network 208 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 206 without departing from the scope of the present invention. Moreover, as used herein, communications include those enabled by wired or wireless technology.

In some embodiments, a suitable wireless communication network 208 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 6 may be equipped with a microchip transceiver that transmits and receives in a previously unused frequency band of 2.45 GHz that is available globally (with some variation of bandwidth in different countries). In addition to data, up to three voice channels are available. Connections can be point-to-point or multipoint over a current maximum range of ten (10) meters. Embodiments using Bluetooth technology may require the additional use of one or more receiving stations to receive and forward data from individual user devices 202 or servers 206.

Although two user devices 202, two user devices 204 and three servers 206 are shown in FIG. 6, any number of such devices may be included in the system 200. The devices shown in FIG. 6 need not be in constant communication. For example, a user device may communicate with a server only when such communication is appropriate or necessary.

As an example of how the system 200 might be used with the methods disclosed herein, a server 206 might send or otherwise provide the notification during the step 102 to one of the user devices 202. The notification provides information regarding an item to be located. The user device 202 or person associated with the user device 202 may search for and locate the item indicated in the notification. Once the item is located, the user device 202 or person associated with the user device 202 might send the notification regarding the location of the item that is received by the server 206 during the step 104. The server 206 may then send a notification during the step 106 to a user device 204 that indicates that the item has been located. A person associated with the user device 204 may have requested that the server send out the notification during the step 102 on the person's behalf.

As another example of how the system 200 might be used with the methods disclosed herein, a server 206 may implement the step 122 and determine an item to be located and an instruction associated with the item. During the step 124, the server 206 may provide a notification regarding the item and the instruction to one of the user devices 204. Presumably, the user device 204 or a person associated with the user device 204 will locate the item and provide a notification regarding the location of the item that is received by the server 206 during the step 126. During the optional step 128, the server 206 might provide a notification to one or more of the user devices 202 that the item has been located or that it received the notification during the step 126.

As yet another example of how the system 200 might be used with the methods disclosed herein, a server 206 might provide a notification during the step 142 regarding an item to be located and an instruction associated with the item. The server 206 may provide the notification to one or more of the user devices 202. During the step 144, the server 206 may provide a notification regarding a single action that can be performed to implement the instruction to the same user device 202. If the user device 202 or a person associated with the user device 202 locates the item and implements or completes the single action, the server 206 will receive a notification during the step 146 of such completion of the single action. The notification might come directly or indirectly from the user device 202. Alternatively, the notification might come directly or indirectly from another device (e.g., another user device or server) or entity that verifies or confirms the completion of the single action.

In some embodiments of any of the methods disclosed herein, a person locating or merely looking for an item on behalf of another person may be compensated for his or her efforts. Thus, in some embodiments, one or more of the methods disclosed herein may include determining a compensation amount or formula to provide to a person locating or looking for an item. The compensation amount of formula may be based on many factors such as, for example, the status of the person wanting to find the item, the value, complexity, rarity, etc. of the item, the time period allowed to find the item, the expertise, profile, occupation, celebrity status, location, availability, etc. of the person looking for the item, the location of the person wanting to find the item, the time spent looking for the item, the number of people involved in looking for the item, etc.

Server

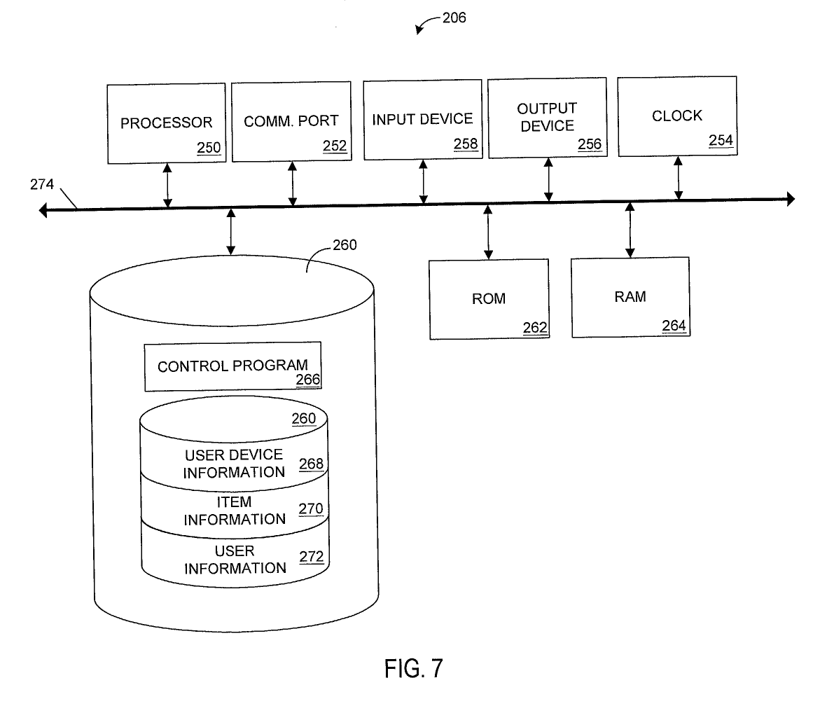

Now referring to FIG. 7, a representative block diagram of a server or controller 206 is illustrated. The server 206 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 206 also may include an internal clock element 254 to maintain an accurate time and date for the server 206, create time stamps for communications or other notifications received or sent by the server 206, etc.

If desired, the server 206 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 206 may include a memory or data storage device 260 to store information, software, databases, communications or other notifications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a ZIP™ disk drive, a compact disc and/or a hard disk. The server 206 also may include ROM 262 and RAM 264 for further storage and memory.

The processor 250 and the data storage device 260 in the server 206 each may be, for example: (i) located entirely within a single computer or other computing device; or

(ii) connected to each other by a remote communication medium, such as a serial port cable, telephone line or radio frequency transceiver. In one embodiment, the server 206 may comprise one or more computers that are connected to a remote server computer for maintaining databases.

A conventional personal computer or workstation with sufficient memory and processing capability may be used as the server 206. In one embodiment, the server 206 operates as or includes a Web server for an Internet environment. The server 206 preferably is capable of high volume transaction processing, performing a significant number of mathematical calculations in processing communications and database searches. A Pentium™ microprocessor such as the Pentium II™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 206. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 206 also may include or store information regarding users, user devices, items, notifications and other communications, etc. For example, information regarding user devices may be stored in a user device database 268 for use by the server 206 or another device or entity, information regarding items may be stored in an item information database 270 for use by the server 206 or another device or entity, and information regarding users may be stored in a user information database 272 for use by the server 206 or another device or entity.

According to an embodiment of the present invention, the instructions of the control program may be read into a main memory from another computer-readable medium, such as from ROM 264 to RAM 262. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 272.

While specific implementations and hardware configurations for servers 206 devices have been illustrated, it should be noted that other implementations and hardware configurations are possible and that no specific implementation or hardware configuration is needed. Thus, not all of the components illustrated in FIG. 7 may be needed for a server implementing the methods disclosed herein. Therefore, many different types of implementations or hardware configurations can be used in the system 200 and the methods disclosed herein are not limited to any specific hardware configuration.

User Devices

As mentioned above, a user device 202 or 204 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, cable set-top box, radio, two-way pager, cash register, etc. If desired, a user device 202 or 204 also may function as a server 206. In some embodiments, a user device 202 or 204 may have the same structure or configuration as the server 206 illustrated in FIG. 7 and some or all of the same components as the server 206.

Databases

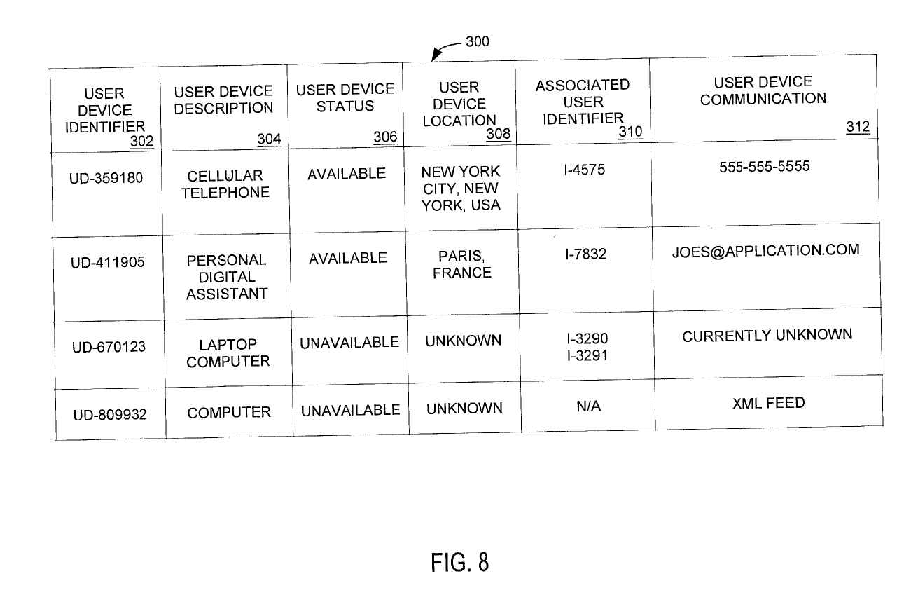

As previously discussed above, in some embodiments a server, user device, or other device may include or access a user device database for storing or keeping information regarding one or more user devices. One representative user device database 300 is illustrated in FIG. 8.

The user device database 300 may include a user device identifier field 302 which may include codes or other identifying information for one or more user devices, a user device description field 304 which may include names and other descriptive information for the user devices identified in the field 302, a user device status field 306 which may include information regarding whether or not the user devices identified in the field 302 are available or accessible, a user device location field 308 which may include information regarding the location of the user devices identified in the field 302, an associated user identifier field 310 which may include information regarding one or more users associated (e.g., using, carrying, wearing) with the user devices identified in the field 302, and a user device communication field 312 which may include information regarding how to communicate with the devices identified in the field 302. Other or different fields also may be used in the user device database 300.

As illustrated in the representative user device database 300, the user device identified as “UD-359180” in the field 302 is a “CELLULAR TELEPHONE” that can be reached by calling “555-555-5555.” The “CELLULAR TELEPHONE” identified as “UD-359180” in the field 302 is currently available (i.e., it is within range or can be contacted) and is currently located in “NEW YORK CITY, NEW YORK, USA.” A user identified as “I-4575” is associated with the user device identified as “UD-359180” in the field 302. Information regarding the user “I-4575” can be found in a user information database. The user identified as “I-4575” in the field 310 for the user device “UD-359180” presumably is carrying the user device and can be reached by calling the telephone number “555-555-5555”.

As illustrated by the entries in the user device database 300 for the user device identified as “UD-670123” in the field 302, a user device may be associated with more than one user and have an unknown location. As illustrated for the entries in the user device database 300 for the user device identified as “UD-809932” in the field 302, a user device may be associated with a user, even if the identify of or identifier for the user is unknown.

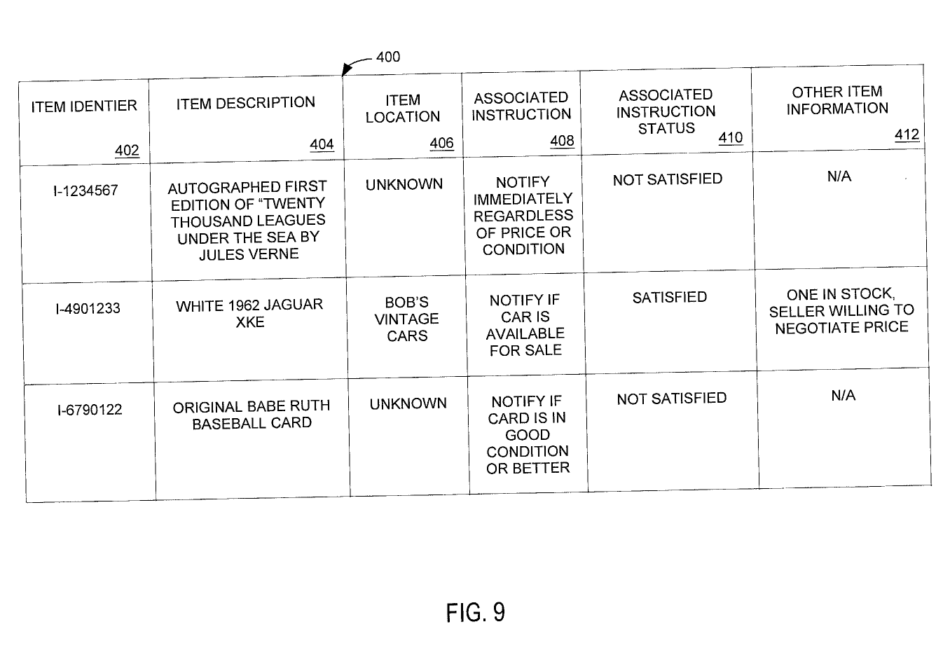

As previously discussed above, in some embodiments a server, user device, or other device may include or access an item database for storing or keeping information regarding one or more items. One representative item database 400 is illustrated in FIG. 9.

The item database 400 may include an item identifier field 402 which may include codes or other identifies for one or more items, an item identifier field 404 which may includes names and other descriptive information for the items identified in the field 402, an item location field 406 which may include location information for the items identified in the field 402, an associated instruction field 408 that may include instructions, single actions, if any, associated with the items identified in the field 402, an associated status field 410 that may include information regarding the status of the instructions indicated in the field 408 for the items identified in the field 402, and an other item information field 412 which may include any additional or miscellaneous information regarding the items identified in field 402. Other or different fields also may be used in the item database 400. For example, the item database 300 could include a user identifier field that provides information regarding users looking for or finding the items identified in the field 402.

As illustrated in the representative item database 400, the item identified as “I-1234567” in the field 402 is an “AUTOGRAPHED FIRST EDITION OF ‘TWENTY THOUSAND LEAGUES UNDER THE SEA’ BY JULES VERNE”. As indicated by the entry in the field 408, a person looking for the booked has specified that they should be immediately notified when the book is found, regardless of the condition or price of the book. The instruction indicated in the field 408 has not been completed, as indicated by the entry in the field 410, presumably because the book has not been found.

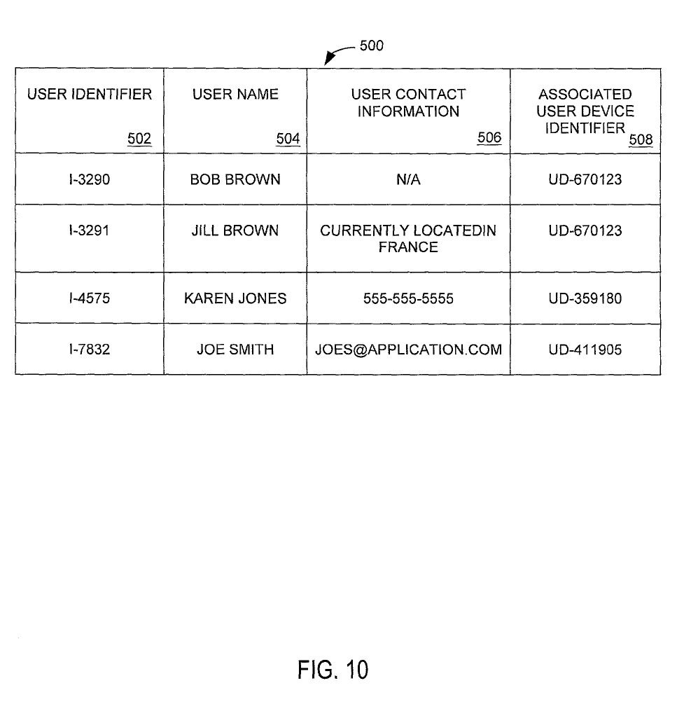

As previously discussed above, in some embodiments a server, user device, or other device may include or access a user database for storing or keeping information regarding one or more users. One representative user database 500 is illustrated in FIG. 10.

The user database 500 may include a user identifier field 502 that includes codes or other identifiers for one or more users, a user name field 504 that may include names for the users identified in the field 502, a user contact information field 506 that may include email addresses, postal addresses, telephone numbers and/or other contact information for the users identified in the field 506, and an associated user device identifier field 508 that may include identifiers for any user devices associated with the users identified in the field 502. Other or different fields also may be used in the user database 500. For example, the user database 300 may also include fields storing demographic information, personal information, financial or credit information, information regarding hobbies, interests and occupations, and other information regarding the users identified in the field 502. As another example, the user database 300 might include contact or address information for one or more people, devices other entities that a person might want to send an item to.

As illustrated in the representative item database 500, the user identified as “U-3290” in the field 502 is named “BOB BROWN” and is associated with the user device “UD-670123”. More information regarding the user device “UD-670123” can be found in the user device database 300 illustrated in FIG. 8.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods 100, 120, 140, 160, and 180 can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating the locating of an item, comprising:
providing a first notification to a first device, said first notification including data indicative of an item to be located;
receiving a second notification, said second notification including data indicative of a location of said item; and
providing a third notification to a second device, said third notification including data indicative of said location of said item.

2. The method of claim 1, wherein said first notification includes at least one of the following:
data indicative of an identifier associated with said item;
data indicative of a desired location for said item;
data indicative of a desired condition of said item;
data indicative of a desired price for said item;
data indicative of a desired amount of said item;
data indicative of a desired maximum price for said item;
data indicative of a desired shipping date for said item;
data indicative of a desired delivery process for said item;
data indicative of a name of said item;
data indicative of a desired configuration of said item;
data indicative of compensation that might be provided to a person locating said item;
data indicative of a description of said item;
data indicative of an instruction associated with said item; and
data indicative of a single action that can be performed when said item is located.

3. The method of claim 1, wherein said second notification includes at least one of the following:
data indicative of a Web site where information regarding said item can be found;
data indicative of a name of said item;
data indicative of a price of a said item;
data indicative of delivery of said item;
data indicative of shipping of said item;
data indicative of packaging of said item;
data indicative of taxes associated with said item;
data indicative of instructions associated with said item;
data indicative of an availability of said item;
data indicative of an identifier associated with said item;
data indicative of a description of said item;
data indicative of a supplier of said item; and
data indicative of a manufacturer of said item.
data indicative of a completion of a single action associated with said item; and
data indicative of a completion of an instruction associated with said item.

4. The method of claim 1, wherein said third notification includes at least one of the following:
data indicative of a Web site where information regarding said item can be found;
data indicative of a name of said item;
data indicative of a price of a said item;
data indicative of delivery of said item;
data indicative of shipping of said item;
data indicative of packaging of said item;
data indicative of taxes associated with said item;
data indicative of instructions associated with said item;
data indicative of an availability of said item;
data indicative of an identifier associated with said item;
data indicative of a description of said item;
data indicative of a supplier of said item; and
data indicative of a manufacturer of said item.
data indicative of a completion of an instruction associated with said item;
data indicative of a completion of a single action associated with said information element.

6. The method of claim 1, wherein said providing a first notification to a first device includes at least one of the following:
sending an electronic communication via a communications network to said first device;
sending an email message via the Internet;
sending a signal via a wireless network;
sending an electronic communication that includes said first notification; and
transmitting an electronic signal containing said first notification via a communications network.

6. The method of claim 1, wherein said providing a third notification to a second device includes at least one of the following:
sending an electronic communication via a communications network to said second device;
sending an email message via the Internet;
sending a signal via a wireless network;
sending an electronic communication that includes said third notification; and
transmitting an electronic signal containing said third notification via a communications network.

7. The method of claim 1, wherein said receiving a second notification includes at least one of the following:
receiving an electronic communication via a communications network from a device;
receiving an email message via the Internet;
receiving a signal via a wireless network;
receiving an electronic communication that includes said second notification; and
receiving an electronic signal containing said second notification via a communication network.

8. The method of claim 1, further comprising:
determining an instruction associated with said item element.

9. The method of claim 8, wherein said instruction includes at least one of the following:
what information should be included in said second notification;
where to send a notification regarding said item;
when to send a notification regarding said item;
how to send a notification regarding said item; and
under what circumstances to send a notification regarding said item.

10. The method of claim 1, further comprising:
determining a single action that can be performed when said item is located.

11. The method of claim 10, wherein said single action is one of the following:
clicking a mouse button when a cursor is positioned over a designated area of an identifier associated with said item;
clicking on a mouse button when a cursor is positioned over a designated area of a Web page;
clicking on a mouse button when a cursor is positioned over a link displayed on a Web page;
selecting a designated Uniform Resource Locator;
selecting a specific channel using a television remote control;
making a specific command using a television remote control;
detecting a presence of said item;
determining a characteristic of said item;
detecting a unique identifying characteristic of said item;
depressing of a key on a key pad;
detecting an identifier associated with said item;
scanning an identifier associated with said item;
selecting an identifier associated with said item;
providing a designated signal;
moving said item within a designated proximity of another item;
moving said item to a designated location; and
moving said item within range of a device capable of detecting a presence of said item;
scanning a code associated with said item;
scanning an image associated with said item;
navigating to a designated Web page;
entering a designated code;
making an designated sound;
selecting using a pointing device; and
moving a cursor over a designated area of an identifier associated with said item.

12. The method of claim 1, wherein said second notification is received from said first device.

13. The method of claim 1, further comprising:
prior to said providing a first notification, receiving a request to locate said item.

14. The method of claim 1, further comprising:
prior to said providing a first notification, determining a need to locate said item.

15. The method of claim 1, further comprising:
prior to said providing a first notification, determining availability of said first device.

16. The method of claim 1, further comprising:
prior to said providing a third notification, determining availability of said second device.

17. The method of claim 1, further comprising:
prior to said providing a first notification, receiving a notification regarding a location of said first device.

18. The method of claim 1, further comprising:
sending said item.

19. The method of claim 1, further comprising:
receiving said item.

20. The method of claim 1, further comprising:
providing a notification regarding compensation available for locating said item.

21. A method for facilitating the locating of an item, comprising:
determining an item to be located and an instruction associated with said item;
providing a first notification, said first notification including data indicative of said item and said instruction;
receiving a second notification, said second notification including data indicative of a location of said item; and
providing a third notification, said third notification including data indicative of at least one of said location of said item and a receipt of said second notification.

22. A method for facilitating the locating of an item, comprising:
providing a notification of an item to be located, said item having an associated instruction;
providing a notification of a single action that can be performed to implement said instruction; and
receiving a notification of a completion of said single action.

23. The method of claim 22, further comprising:
providing a notification of said completion of said single action.

24. A method for facilitating the locating of an item, comprising:
providing information identifying an item to be located; and
providing information regarding a single action to be performed when said item is located.

25. The method of claim 24, further comprising:
in response to only said single action, providing a notification that includes data indicative of a location of said item.

26. The method of claim 24, further comprising:
in response to a notification that said single action has been completed, providing a notification that includes data indicative of said location of said item.

27. The method of claim 24, further comprising:
in response to a notification that said single action has been completed, providing a notification that includes data indicative of a completion of said single action.

28. The method of claim 24, further comprising at least one of the following:
sending said item; and
receiving said item.

29. The method of claim 24, wherein completion of said single action will cause at least one of the following to occur:
said item being sent to a designated postal address;
said item being sent to a designated electronic address;
a notification being sent regarding completion of said single action;
a notification being sent regarding said item;
said item being purchased;
said item being placed in an electronic shopping cart;
a bid being placed on said item;
an reservation being made for said item; and
an order being placed for said item.

30. The method of claim 24, further comprising:
receiving a notification that said item is to be located.

31. The method of claim 24, further comprising:
determining that said item is to be located.

32. A method for facilitating the locating of an item, comprising:
determining an item to be located and an instruction associated with said item that is to be completed when said item is located; and
providing a notification to a first device, said notification including data indicative of said item and said instruction.

33. The method of claim 31, wherein said instruction associated with said item includes one of the following:
an instruction that said item should be purchased when said item is located;
an instruction regarding a single action that should be completed when said item is located;
an instruction that said item should be placed in an electronic shopping cart when said item is located;
an instruction that said item should be ordered when said item is located;
an instruction that a reservation for said item should be made when said item is located;
an instruction that a bid should be placed on said item;
an instruction that a notification should be sent when said item is located, said notification including data indicative of a location of said item;
an instruction that a notification should be sent when said item is located, said notification including data indicative of a description of said item;
an instruction that a notification should be sent when said item is located, said notification including data indicative of a payment term associated with said item;
an instruction that a notification should be sent when said item is located, said notification including data indicative of a delivery requirement associated with said item;
an instruction that a notification should be sent when said item is located, said notification including data indicative of a shipping requirement associated with said item;
an instruction that a notification should be sent when said item is located, said notification including data indicative of a price of said item; and
an instruction that a notification should be sent when said item is located, said notification including data indicative of an availability of said item.

34. A method for facilitating transfer of an item, comprising:
receiving a notification regarding an item to be located and a single action associated with said item, wherein completion of said single action will cause a designated event to occur;
determining a location of said item; and
completing said single action when said location of said item is determined.

35. The method of claim 34, wherein said single action is one of the following:
clicking a mouse button when a cursor is positioned over a designated area of an identifier associated with said item;
clicking on a mouse button when a cursor is positioned over a designated area of a Web page;
clicking on a mouse button when a cursor is positioned over a link displayed on a Web page;
selecting a designated URL;
selecting a specific channel using a television remote control;
making a specific command using a television remote control;
contacting a specific portion of a touchscreen;
calling a specific telephone number;
detecting a presence of said item;
determining a characteristic of said item;
detecting a unique identifying characteristic of said item;
depressing of a key on a key pad;
providing a designated signal;
detecting an identifier associated with said item;
scanning an identifier associated with said item;
selecting an identifier associated with said item;
moving said item within a designated proximity of another item;
moving said item to a designated location;
moving said item within range of a device capable of detecting a presence of said item;
scanning a code associated with said item;
scanning an image associated with said item;
navigating to a designated Web page;
entering a designated code;
making an designated sound;
selecting using a pointing device; and
moving a cursor over a designated area of an identifier associated with said item.

36. The method of claim 34, wherein said designated event includes at least one of the following:
a notification regarding said item being sent to a designated postal address;
a notification regarding said item being sent to a designated electronic address;
said item being sent to a designated postal address;
said item being sent to a designated electronic address;
said item being purchased;
said item being placed in an electronic shopping cart;
a bid being placed on said item;
an reservation being made for said item; and
an order being placed for said item.

37. A system for facilitating locating of an item, comprising:
a memory;
a communication port; and
a processor connected to said memory and said communication port, said processor being operative to:
provide a first notification to a first device, said first notification including data indicative of an item;
receive a second notification, said second notification including data indicative of a location of said item; and
provide a third notification to a second device, said third notification including data indicative of said location of said item.

38. A computer program product in a computer readable medium for facilitating locating of an item, comprising:
first instructions for sending data indicative of an item to a first device;
second instructions for receiving data indicative of a location of said item; and
third instructions for sending data indicative of said location of said item to a second device.
